(19) United States
(12) Patent Application Publication
(10) Pub. No.: US 2008/0306657 A1
(43) Pub. Date: Dec. 11, 2008

(54) Control Device and Method for Deploying a Protective Means for Rollover Protection for Motor Vehicles

(75) Inventors: Peter Lohberg, Friedrichsdorf (DE); Frank Jourdan, Buttelborn (DE); Michael Zydek, Frankfurt am Main (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG, Frankfurt am Main (DE)

(21) Appl. No.: 10/583,624

(22) PCT Filed: Dec. 17, 2004
(86) PCT No.: PCT/EP2004/053574

§ 371 Date: Jun. 20, 2006

(30) Foreign Application Priority Data
Dec. 24, 2003 (DE) 103 61 240.8
Dec. 2, 2004 (DE) 10 2004 058 129.0

(51) Int. Cl. G06F 7/00

(52) U.S. Cl. 701/46; 701/45

(57) ABSTRACT

A control device of a protective means for rollover protection for a motor vehicle includes a rotational acceleration sensor for the rotational acceleration about the longitudinal axis of the vehicle (rolling motion of the vehicle) and an analyzer device for analyzing the rotational acceleration (angular acceleration). A signal that depends on the rotational acceleration is output by the analyzer device for the protective means for rollover protection.

### BACKGROUND OF THE INVENTION

The invention relates to a control device of at least one protective means for rollover protection for occupants of a motor vehicle and a method for deploying a protective means for rollover protecting the occupants of a vehicle.

The invention also relates to a restraint system for protecting occupants of a vehicle.

Vehicles today usually have airbag systems for protecting the occupants of the vehicle in the event of an accident.

Simple airbag systems have at least one or two front air bags, deployment of which is controlled by a control unit. From linear acceleration generators, the control unit receives signals containing information about the size and direction of the linear vehicle acceleration. The front airbags are deployed when a certain vehicle deceleration in the frontal direction is exceeded.

A more complex airbag system will have additional side airbags and/or head airbags. Other acceleration sensors are provided for this purpose in the door area of the vehicle to measure the acceleration in the transverse direction when there is a side impact, i.e., across the longitudinal axis of the vehicle. If a certain transverse acceleration threshold is exceeded, the side airbags are deployed in addition to the front airbags.

The object of the present invention is to create a device and a method for deploying an occupant protection means for motor vehicles that will permit reliable deployment of the occupant protection system in the event of a vehicle rollover.

### SUMMARY OF THE INVENTION

According to this invention, this object is achieved by the fact that at least-one-rotational acceleration sensor is assigned to the control device for detecting the rotational acceleration about the longitudinal axis of the vehicle and at least one analyzer device for analyzing the rotational acceleration (angular acceleration) thus detected is assigned to the control device, and a control signal that depends on the rotational acceleration thus detected is output by the analyzer device for the protective means for rollover protection of the occupants.

The terms “rotation” and “rotational acceleration” as used here are based essentially on a rotational movement of the vehicle about the longitudinal axis of the vehicle and therefore are also referred to below as “rolling” and/or as “rolling acceleration.” Likewise, for certain application cases, the control device according to this invention is to be employed similarly for rotation and/or rotational acceleration of the vehicle about the transverse direction of the vehicle. This permits deployment of occupant safety equipment in the event of a vehicle rollover about a transverse axis of the vehicle.

Measurements with the rotational acceleration sensor according to this invention in comparison with measurements with rolling rate sensors results in a more direct detection of a sudden rollover impulse of the vehicle than a rolling speed (rolling rate) which has an aftereffect. Due to this better detection of the angular momentum with the rotational acceleration sensor, a safety-critical rollover impulse can be detected sooner and more reliably than with a rolling rate sensor.

According to the present invention, the control device does not have a rolling rate sensor for detecting the rotational motion about the longitudinal axis of the vehicle.

According to this invention, the control device does not have an inclination sensor for detecting inclination of the vehicle about the longitudinal axis of the vehicle.

According to this invention, the rotational acceleration sensor is an optical, capacitive or inductive sensor, preferably a silicon micromechanical sensor. The term “silicon micromechanical” sensor as used here refers to a sensor based on silicon (Si) produced by a micromechanical process.

The rotational acceleration sensor is preferably a so-called “passive” sensor. It differs from a rolling rate sensor by means of which a rotational speed or rolling speed is recorded in that the rotational acceleration sensor does not have an internal mass element (arranged in the sensor module) and does not operate on the basis of an oscillatory movement of mass elements. No internal component need be activated with the passive rotational acceleration sensor according to this invention, so there is advantageously no need for a drive, a so-called “drive drive,” for vibration excitation.

According to this invention, the protective means include at least one occupant restraint means, in particular a side airbag and optionally an activatable rollover protection means such as retractable or foldout rollover bars or head supports.

According to this invention, the control device is assigned to (redundant) rotational acceleration sensors.

According to this invention, this object is achieved by a restraint system for protecting occupants of a vehicle and is characterized in that the restraint system has at least one side airbag and one control device according to this invention by means of which control device the side airbag is deployed.

In the method for deployment of a safety means, this object is achieved according to this invention by the fact that by means of at least one rotational acceleration sensor, a rotation acceleration (angular acceleration) about the longitudinal axis of the vehicle is detected; the rotational acceleration thus detected or a quantity derived therefrom is compared with a limit value that is either determined or preselected, in particular a rotational acceleration limit value, and the protective means is deployed when the rotational acceleration thus detected or the quantity derived therefrom exceeds the limit value.

According to this invention, a first and a second rotational acceleration (angular acceleration) are detected by means of two rotational acceleration sensors in this method; the two rotational accelerations thus detected or quantities derived therefrom are compared with one another, and depending on the results of the comparison, a plausibility check of the signals of the two rotational acceleration sensors is performed.

The proposed control device and the inventive method serve in particular to measure rolling movements of the vehicle for use in airbag systems. According to this invention, a system configuration having side airbags is supplemented by a rotational acceleration sensor or in an airbag system configuration having rolling rate sensors, these rolling rate sensors are replaced by rotational acceleration sensors.

Using the present invention yields a safety advantage of improved stability in sensory detection of critical driving situations and does so at a comparatively low cost. This makes it possible to reduce the consequences of accidents and/or increase the safety of passengers in street traffic in general.

According to this invention the control device and the method according to this invention are used similarly for pitching movements of the vehicle about the transverse direction of the vehicle. Therefore occupant safety equipment can be deployed reliably even in the event of a rollover of the vehicle about a transverse axis of the vehicle.

This invention is explained in greater detail below on the basis of exemplary embodiments and illustrations

### BRIEF DESCRIPTION OF THE DRAWINGS

In the drawings,

FIG. 1 shows a vehicle coordinate system;

FIG. 2 shows a diagram of a simple airbag system according to the state of the art;

FIG. 3a shows a diagram of an expanded airbag system according to the state of the art;

FIG. 3b shows a diagram of an expanded airbag system according to this invention;

FIG. 4 shows a diagram of an airbag system expanded according to this invention;

FIG. 5 shows a diagram of an airbag system with additional sensor information.

### DETAILED DESCRIPTION OF THE DRAWINGS

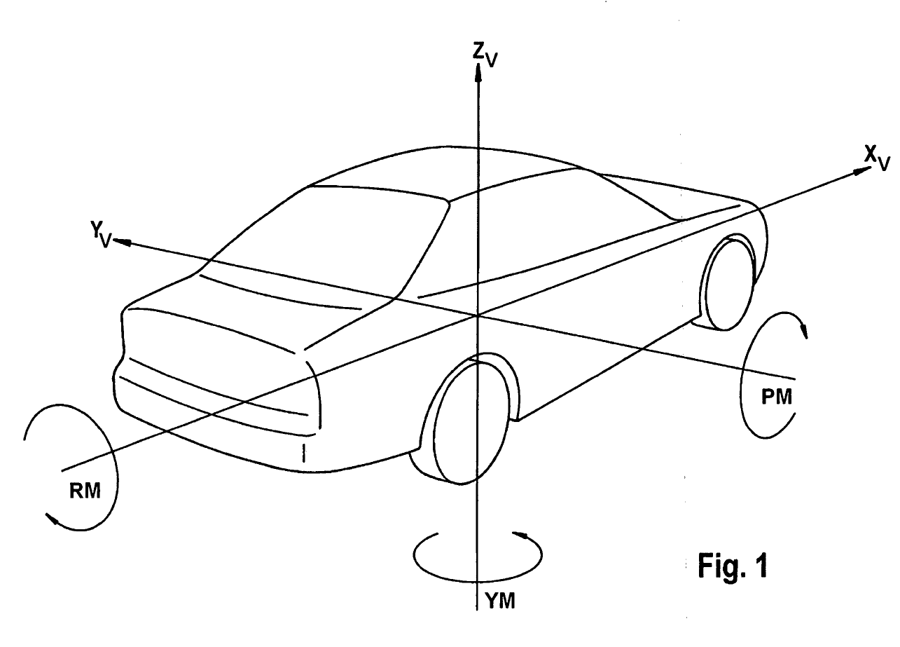

FIG. 1 shows a vehicle coordinate system, showing the naming of the axes and movements of the vehicle about these axes, where Xᵥ is the direction of the vehicle and RM is the rolling movement about the direction of the vehicle, i.e., about the longitudinal axis of the vehicle. The pitching motion PM takes place about the transverse direction Yᵥ of the vehicle and the yawing motion YM is about the vertical axis Zᵥ of the vehicle.

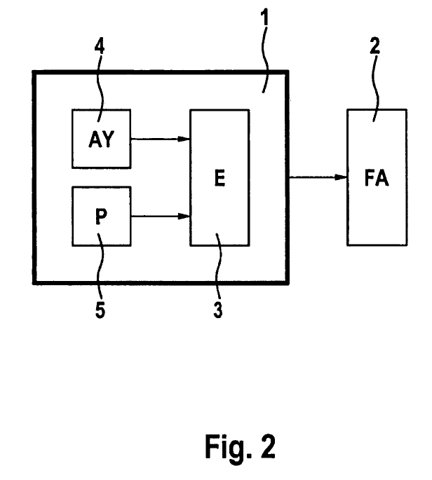

FIG. 2 shows schematically a simple airbag system according to the state of the art. It consists of an arrangement of airbag actuators 2, i.e., one or two front air bags (FA), deployment of which is controlled by a control unit 1. To this end, the control unit has as essential components a specific electronic controller (E) 3 to which information about the size and direction of the vehicle acceleration is sent continuously through two acceleration sensors (AY), (P) integrated into the controller housing, where AY is a high resolution precision acceleration sensor and P is a mechanically sturdy but usually less precise acceleration measurement device used for a plausibility check on the information provided by AY. When a certain vehicle deceleration in the frontal direction is exceeded, this is evaluated by the controller as a safety-critical situation which then causes deployment (firing) of the front airbags FA immediately thereafter.

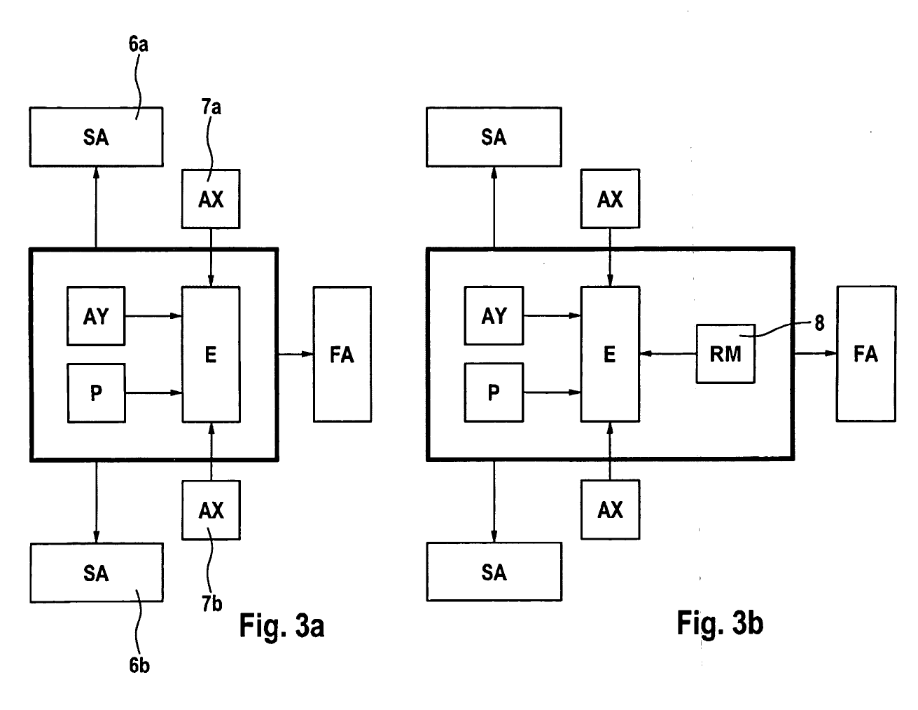

FIG. 3a shows schematically an-arrangement according to FIG. 2 but with additional side air bags according to the state of the art, where 6a, 6b denote airbag arrangements (SA) on the right and left sides of the vehicle and 7a, 7b denote the respective precision acceleration sensors (AX) which are installed as so-called satellites in the door area of the vehicle outside of the control unit. The signals of these sensors are sent to the control unit. In the case of a side impact, the satellite sensors measure the momentum acceleration of the transverse components and trigger the deployment of the front air bags as well as the respective side air bags via the control algorithm when a certain safety-critical transverse acceleration threshold is exceeded.

FIG. 3b shows an inventive expansion of the system according to FIG. 3a. One idea of the present invention is to supplement the system by adding a rotational acceleration sensor 8. The rotational acceleration sensor (RM) is preferably arranged in the controller housing and measures the rotational acceleration (rolling acceleration) of the longitudinal axis Xᵥ of the vehicle according to FIG. 1.

The measurement with the rotational acceleration sensor according to this invention in comparison with systems in which the rolling rate of the longitudinal axis of the vehicle is measured by rolling rate sensors has the advantage that when there are impact-like rolling impulses, the rolling motion quantity is measured with the rotational acceleration sensor, hereinafter also referred to as the “rolling acceleration sensor,” and this quantity is better adapted to the rotational impulse than the respective rolling rate, which develops subsequently. The rolling acceleration sensor supplies a direct definite signal at the point of time when the rolling rate signal still has an unsatisfactory signal to noise ratio. The inventive system is capable of responding more rapidly.

In systems which have previously been designed without any measurement of rotational motion, there is increased expense due to the use of the additional rolling acceleration sensor according to this invention, but the technical safety advantage far outweighs this.

In comparison with today's systems, which already have an integrated rolling rate sensor, a significant cost advantage is also obtained when this sensor is replaced by a rolling acceleration sensor according to this invention—in addition to the technical advantage explained above—because a rolling acceleration sensor of a comparable functionality is definitely less expensive than today's rolling rate sensors.

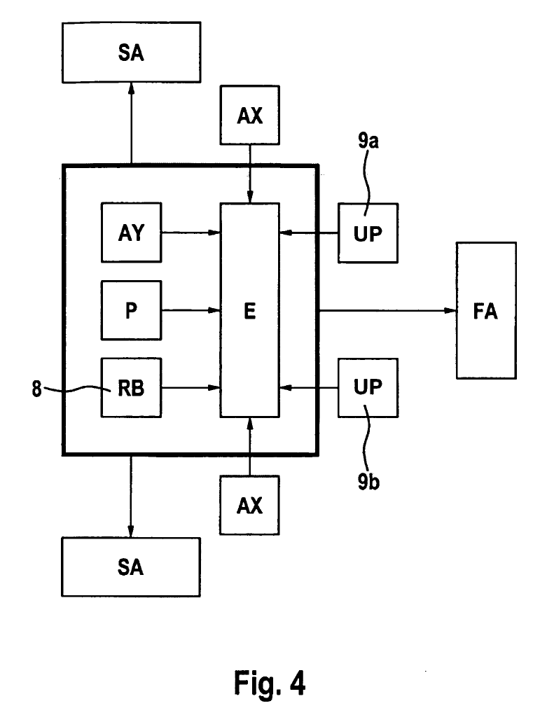

FIG. 4 illustrates the application of this invention to an airbag system with additional “upfront sensors” 9a, 9b which are normally situated between the lights and the radiator, are selectively active in the direction of travel and are connected as additional satellite sensors via cable to the control unit. According to the present invention, this high-safety arrangement can be improved in its system properties in an especially advantageous manner by using an inexpensive rolling acceleration sensor 8.

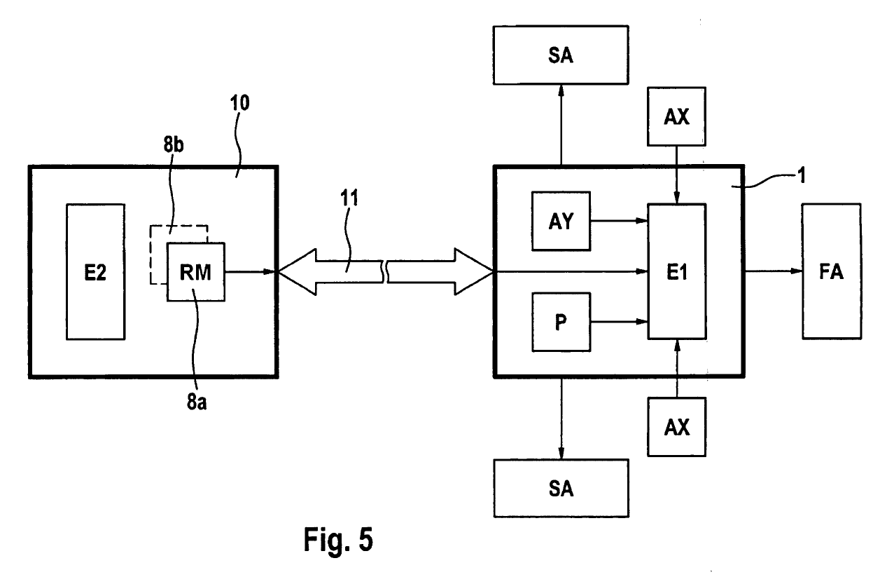

FIG. 5 illustrates another advantageous application of the invention in which, in contrast with the exemplary embodiments already described, a rotational acceleration sensor 8a cooperates with an airbag system according to this invention, e.g., via a fast bus connection 11 which is not integrated into the airbag control unit 1 but instead is in another apparatus residing in the vehicle, in particular an ESP control unit 10. The advantage of this arrangement is the use of the same sensor function unit by two different vehicle systems. This advantage is also obtained in particular when a redundant rotational acceleration sensor 8b is necessary for technical safety reasons. Therefore, especially in the sense of the present invention, a redundant arrangement is to be used in the joint use of rotational acceleration information, thereby increasing the system reliability of both systems but also achieving a comparatively inexpensive implementation.

1-10. (canceled)

11. A control device of at least one protective device for rollover protection for occupants of a motor vehicle, wherein the control device is provided with at least one rotational acceleration sensor for detecting a rotational acceleration about the longitudinal axis of the vehicle and at least one analyzer device for analyzing the detected rotational acceleration (angular acceleration), and for generating a control signal for the protective device for rollover protection of the occupants, said signal depending on the detected rotational acceleration.

12. The control device according to claim 11, wherein the rotational acceleration is the only measured quantity relating to a rotation or inclination of the vehicle about the longitudinal vehicle axis.

13. The control device according to claim 11, wherein the rotational acceleration sensor is a silicon micromechanical sensor.

14. The control device according to claim 13, wherein the rotational acceleration sensor is a passive sensor designed as a micromechanical sensor unit.

15. The control device according to claim 11, wherein the protective device has at least one occupant restraint device.

16. The control device according to claim 15, wherein the occupant restraint device includes at least one side airbag.

17. The control device according to claim 11, wherein the protective device has at least one activatable rollover protection device for head protection.

18. The control device according to claim 11, wherein the control device has two redundant rotational acceleration sensors.

19. A restraint system for protecting occupants of a vehicle, wherein the restraint system has at least one side airbag and one control device, the control device being provided with at least one rotational acceleration sensor for detecting a rotational acceleration about the longitudinal axis of the vehicle and at least one analyzer device for analyzing the detected rotational acceleration, and for generating a control signal for the side airbag, said signal depending on the detected rotational acceleration.

20. A method for deploying a protective device for rollover protection of occupants for a motor vehicle, the method comprising the steps of
measuring a rotational acceleration about the longitudinal axis of the vehicle;
comparing the detected rotational acceleration or a quantity derived therefrom with a limit value,
generating a signal for deploying the protective device when the detected rotational acceleration or the quantity derived therefrom exceeds the limit value, and
deploying the protective device.

21. The method according to claim 20, comprising the steps of
measuring a first and a second rotational acceleration;
comparing the two rotational accelerations or quantities derived therefrom with one another and,
depending on the result of the comparison, performing a plausibility check based on the comparison.
